(19) United States
(12) Patent Application Publication
(10) Pub. No.: US 2015/0127488 A1
(43) Pub. Date: May 7, 2015

(54) METHODS AND SYSTEMS FOR MATCHING REAL ESTATE AGENTS AND CLIENTS

(71) Applicant: William CUTLER, Austin, TX (US)

(72) Inventor: William CUTLER, Austin, TX (US)

(21) Appl. No.: 14/073,842

(22) Filed: Nov. 6, 2013

(51) Int. Cl. G06Q 30/06; G06Q 30/02; G06Q 50/16

(52) U.S. Cl. CPC G06Q 30/0617; G06Q 50/16; G06Q 30/0282
USPC 705/26.43

(57) ABSTRACT

Embodiments described herein disclose methods and systems for a centralized interface where real estate agents, home buyers, and home sellers may interact with one another. The centralized interface may present information associated with a property a home seller desires to sell, features associated with a property that a home buyer desires to purchase, a real estate agent's commission rate, and information associated with the quality of the real estate agents, which may affect the price the home buyer buys or home seller sells their property.

### BACKGROUND INFORMATION

1. Field of the Disclosure

Examples of the present disclosure are related to techniques for matching home buyers and sellers with real estate agents. More specifically, example embodiments disclose matching home buyers and sellers with real estate agents based on the real estate agent's ratings and commission rate or commission rebate rate.

2. Background

Conventionally to sell or buy a home, a home seller or home buyer will contact real estate agents via phone calls, emails, advertisements, etc. to obtain a commission estimate for selling the home or buying the home. This process may be difficult for a home seller or home buyer because the home seller or home buyer may not be accustomed to negotiating commission rates with a real estate agent, may not know standard commission rates, may not know the skill of a real estate agent, may not know that different real estate agents charge different commission rates, or may not know that real estate agents may charge different commission rates for different properties.

Conventionally to attract home buyers and home sellers, real estate agents are required to spend time and money on websites, postcards, magazine ads, newspaper ads, search engine ads, etc. By being required to spend time and money to attract home buyers and sellers, real estate agents have to increase their rates.

Accordingly, needs exist for more efficient and effective methods and systems to match real estate agents and home buyers and home sellers, where the home buyers and home sellers may be presented with information associated with the real estate agents' ratings and rates.

### SUMMARY

Embodiments disclosed herein provide systems and methods for home buyers and sellers to generate listings, where real estate agents submit offers to buy or sell a property for the home buyers and/or home sellers. In embodiments, the generated listings may be presented to the real estate agents for a listing period of time, which may be any desired length of time such as one week. During the listing period of time, real estate agents may submit offers to buy or sell the property, wherein the offers may include a commission rebate rate or a commission rate, respectively.

After the listing period of time has elapsed, the home buyer or seller may have a selection period of time to select one of the offers from the real estate agents or to decline all of the offers. The selection period of time may be any desired length of time, such as one week. In embodiments, the selection period of time and/or the listing period of time may be set by the home buyer or the home seller.

Responsive to the home buyer or the home seller selecting an offer from one of the real estate agents, a contract will be presented to the home buyer or home seller and the selected real estate agent. The contract may include the commission rebate rate or the commission rate included in the offer received from the real estate agent. Properties being sold may then be added to a MLS database making the properties accessible to all home buyers.

In embodiments, a contract between a home buyer and a selected real estate agent may be for a first period of time (i.e. 180 days), and a contract between a home seller and a real estate agent may be for a second period of time (i.e. 365 days).

In embodiments, responsive to the first period of time lapsing for home buyers, the second period of time lapsing for home sellers, or a property being sold, the home buyer or seller may be transmitted a notification to write a review for and/or rate the selected real estate agent. The ratings for the real estate agent may be based on an initial asking price to buy or sell a property, the actual buying or selling price of the property, and/or the amount of time used by the real estate agent to buy or sell the property. Therefore, the ratings of the real estate agent may be based on timing and/or the expectations of home buyers and sellers and the price of property bought and/or sold.

In embodiments, a selected real estate agent may be required to pay a first fee to buy a home for a home buyer, and a selected real estate agent may be required to pay a second fee to sell a home for a home seller. The first fee and the second fee may be any desired fee, such as one hundred dollars for the first fee and two hundred dollars for the second fee.

These, and other, aspects of the embodiments will be better appreciated and understood when considered in conjunction with the following description and the accompanying drawings. The following description, while indicating various embodiments and numerous specific details thereof, is given by way of illustration and not of limitation. Many substitutions, modifications, additions or rearrangements may be made within the scope of the embodiments, and the embodiments include all such substitutions, modifications, additions or rearrangements.

### BRIEF DESCRIPTION OF THE DRAWINGS

Non-limiting and non-exhaustive embodiments are described with reference to the following figures, wherein like reference numerals refer to like parts throughout the various views unless otherwise specified.

FIG. 1 depicts an embodiment of a network topology for a centralized system to connect home buyers and sellers with real estate agents.

FIG. 2 depicts an embodiment of a block diagram depicting example components of a data server.

FIG. 3 depicts an embodiment of a block diagram illustrating example components of a computing device.

FIG. 4 depicts an embodiment of a method for a home seller selecting a real estate agent to sell a property.

FIG. 5 depicts an embodiment of a method for a home buyer selecting a real estate agent to buy a property.

FIG. 6 depicts an embodiment of an interface configured to be presented on a client computing device associated with a home seller.

FIG. 7 depicts an embodiment of an interface configured to be presented on a client computing device associated with a home buyer.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

In the following description, numerous specific details are set forth in order to provide a thorough understanding of the present embodiments. It will be apparent, however, to one having ordinary skill in the art that the specific detail need not be employed to practice the present embodiments. In other instances, well-known materials or methods have not been described in detail in order to avoid obscuring the present embodiments.

Reference throughout this specification to “one embodiment”, “an embodiment”, “one example” or “an example” means that a particular feature, structure or characteristic described in connection with the embodiment or example is included in at least one embodiment of the present embodiments. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Embodiments disclosed herein provide systems and methods are directed towards a centralized interface where real estate agents, home buyers, and sellers may interact with one another. The centralized interface may present information associated with a property a home seller desires to sell, features associated with a property that a home buyer desires to purchase, a real estate agent's commission rate and commission rebate rate, and information associated with the quality of the real estate agents, which may affect the price the home buyer buys or home seller sells their property.

Because the quality of the real estate agent may affect the price a home buyer buys a property or the price a home seller sells a property, home buyers and sellers may not always want to use a real estate agent with the lowest fee or a fixed cost. Accordingly, because the price of a property is not set at a fixed fee, home buyers and home sellers may desire to select a real estate agent with a higher rating who may be able to sell a house for a higher price or buy a house for a lower price even if the real estate agent does not have the lowest fee.

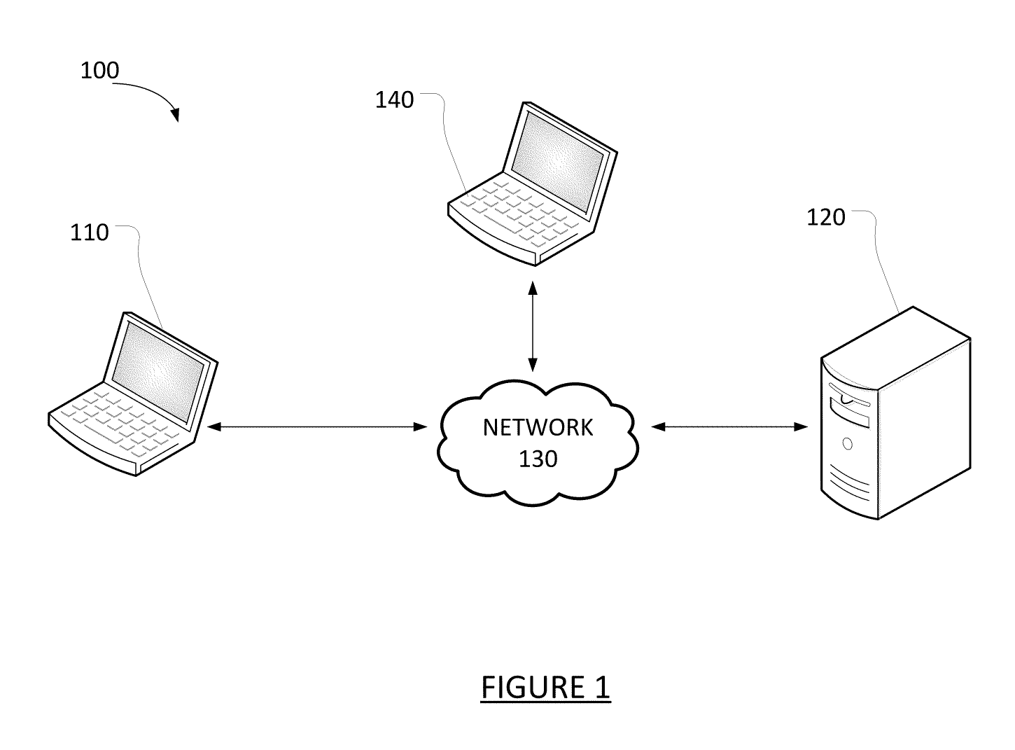

Turning now to FIG. 1, FIG. 1 depicts one embodiment of a network topology 100 for a centralized system to connect home buyers and sellers with real estate agents. Topology 100 includes one or more home buyers or sellers (referred to hereinafter collectively and individually as “client”) computing devices 110, real estate agent computing device 140 connected to data server 120 over network 130.

Network 130 may be a wired or wireless network such as the Internet, an intranet, a LAN, a WAN, a cellular network or another type of network. It will be understood that network 130 may be a combination of multiple different kinds of wired or wireless networks.

Client computing device 110 may be a smart phone, tablet computer, laptop computer, personal data assistant, desktop computer or any other type of computing device with a hardware processor that is configured to process instructions and connect to one or more portions of network 130. Client computing device 110 may be configured to allow a home buyer or seller to input information that may be communicated to data server 120, interact with an interface associated with data server 120, view information associated with real estate agents, write a review for a real estate agent, rank a real estate agent, or select a real estate agent. In embodiments, a home seller may use client computing device 110 to generate a listing including a photo of a property, a city associated with the property, zip code associated with the property, square footage of the property, and other information associated with the property. In embodiments, a home buyer may use client computing device 110 to generate a listing of attributes of a type of property that the home buyer desires to purchase. A home buyer or seller may use client computing device 110 to review and select a real estate agent.

Real estate computing device 140 may be a smart phone, tablet computer, laptop computer, personal data assistant, desktop computer or any other type of computing device with a hardware processor that is configured to process instructions and connect to one or more portions of network 130. Real estate computing device 140 may be configured to allow a real estate agent to input information that may be communicated to data server 120, interact with an interface associated with data server 120, view information associated with properties for home buyers, input a commission rate for selling a house, or input a commission rebate for buying a house. In embodiments, a real estate agent may utilize real estate computing device 140 to view what current offers the real estate agent has pending, what offers are accepted by home buyer and/or home sellers, and/or past offers submitted or accepted.

Data server 120 may be a computing device such as a general hardware platform server that is configured to support mobile applications, software, computer code stored on a non-transitory computer readable medium, and the like executed on client computing device 110 or real estate computing device 140. Data server 120 may include physical computing devices residing at a particular location or may be deployed in a cloud computing network environment. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

Data server 120 may include any combination of one or more computer-usable or computer-readable media. For example, data server 120 may include a computer-readable medium including one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Data server 120 may be configured to communicate information to and from home buyers, home sellers, and real estate agents over network 120. The communicated information may be presented to on client computing device 110 and real estate agent computing device 140 based on a commission rate, a commission rebate, a real estate agents' ratings, real estate agents' reviews, and/or the real estate agents' number of years of experience.

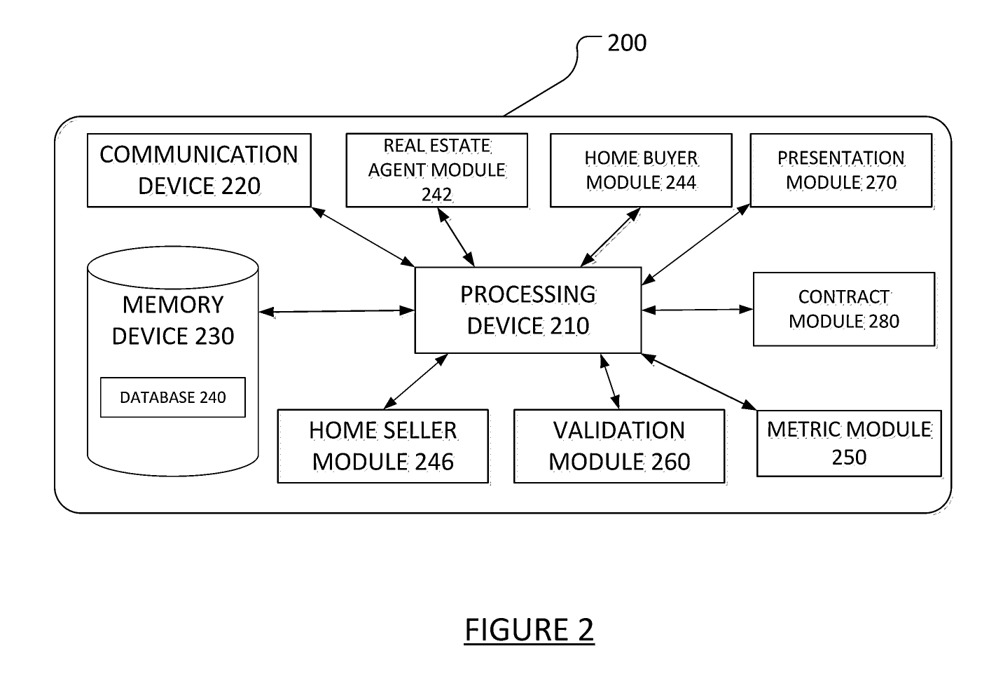

FIG. 2 depicts an embodiment of a block diagram depicting example components of a data server 200, which may be a hardware computing device that is, or is similar to data server 120, as depicting in FIG. 1. Data server 200 may include a processing device 210, a communication device 220, a memory device 230 with a database 240, a real estate agent module 242, a home buyer module 244, a home seller module 246, a metric module 250, a real estate agent validation module 260, presentation module 270, and a contract module 280.

Processing device 210 may include memory, e.g., read only memory (ROM) and random access memory (RAM), storing processor-executable instructions and one or more processors that execute the processor-executable instructions. In embodiments where processing device 210 includes two or more processors, the processors may operate in a parallel or a distributed manner. Processing device 210 may execute an operating system of data server 200 or software associated with data server 200.

Communication device 220 may be a device that allows data server 200 to communicate with another device, e.g., a client computing devices or a real estate computing device over a network. Communication device 220 may include one or more wireless transceivers for performing wireless communication and/or one or more communication ports for performing wired communication. In embodiments, communication device 220 may be configured to receive to be stored in memory device 230, and/or data to be utilized by modules 242, 244, 246, 250, 260, 270, or 280.

Memory device 230 may a device that stores data generated, transmitted, or received by data server 200. Memory device 230 may include, but is not limited to being a hard disc drive, an optical disc drive, and/or a flash memory drive. Memory device 230 may be accessible to processing device 210, communication device 220, and modules 242, 244, 246, 250, 260, 270, or 280.

In embodiments, memory device 230 may store a database 240 including a plurality of entries associated with real estate agents, home buyer's preferences, and/or a home seller's listing.

The database entries associated with a real estate agent may include the real estate agent's name, the location of the real estate agent, the real estate agent's license number, commission rebates associated with home buyers, commission rates for property listings, and home buyers' and sellers' ratings and reviews for the real estate agent. Additionally, the database entries associated with a real estate agent may include pending offers and their corresponding commission rates or commission rebate rates, accepting offers and their corresponding commission rates or commission rebate rates, and historical offers associated with the real estate agent and their corresponding commission rates or commission rebate rates.

The database entries associated with home buyers may include the location the home buyer is interested in purchasing a home, the price range the home buyer desires to buy a house, the type of purchase, the type of property, or any other attributes associated with a type of property the home buyer desires to purchase.

The database entries associated with home seller may include the location the property the home seller is interested in selling, the desired selling price range of the property, attributes of the property such as the number of bedrooms, bath, square footage, etc.

Real estate agent module 242 may be configured to receive data associated with real estate agents who desire to sell properties for home sellers and to buy properties for home buyers. In embodiments, real estate agent module 242 may receive information from real estate computing devices associated with a real estate agent such as: the real estate agent's number of years of experience, the real estate agent's MLS or license number, a zip code or locations that the real estate agent desires to sell or buy properties, the real estate agent's name, a picture of the real estate agent, a password and login for the real estate agent, contact information of the real estate agent, etc. Real estate agent module 242 may also be configured to receive a commission rate that a real estate agent desires to sell a specific property for a specific home seller, or a commission rebate that the real estate agent will give to a home buyer if the real estate agent buys a property for a home property. In embodiments, the commission rate may be represented as a percentage of the value that a property is sold, and the commission rebate may be presented as a percentage of the real estate agent's fee for buying a property. Real estate agent module 242 may also be configured to receive ratings and reviews from home buyers and sellers associated with the real estate agent. The ratings of the real estate agent may be alphabetical or numerical metrics that are configured to identify the quality of the real estate agent, where the quality of the real estate agent may be used to identify a higher price that a real estate agent may be able to sell a property for a home seller, a lower price that a real estate agent may be able to buy a property, or if the real estate agent was able to buy or sell a house within a desired time period. In embodiment, the ratings of the real estate agent may be higher if the real estate agent was able to sell a property for a higher amount than the price listed for by a home seller or if the real estate agent was able to buy a comparable property for less than what was required or desired by a home buyer. The real estate agent's rating may increase if the real estate agent is able to sell a property or buy a property in a shorter period of time. The real estate agent's reviews may be comments by home buyers and sellers associated with the real estate agent's service.

Home buyer module 244 may be configured to receive information from client computing device associated with a home buyer desiring to purchase a property. The received information from the client computing device may include the location the home buyer is interested in purchasing a home, the price range the home buyer desires to buy a house, the type of purchase, the type of property, or any other attributes associated with a type of property the home buyer desires to purchase. Responsive to receiving the information from client computing devices from home buyers desiring to purchase a property, a real estate agent using a real estate computing device may transmit a commission rebate offer. The transmitted commission rebate offer may indicate a commission rebate percentage of the real estate agent's commission that the real estate agent will rebate to the home buyer if the real estate agent purchases a property for the home buyer. Responsive to receiving a commission rebate offer from a real estate agent, home buyer module 244 may parse a database entry within database associated with the real estate agent to receive information associated with the real estate agent's name, years of experience, rating, and reviews.

In embodiments, home buyer module 244 may be configured to determine the location where the home buyer desires to purchase a property, and compare the location where the home buyer desires to purchase the property with the locations associated with real estate agents with entries within database 240 desire to sell property. Responsive to determining a match in locations, home buyer module 244 may transmit a notification to the real estate agent including information indicating that a new home buyer desires to purchase a property within the location.

In embodiments, responsive to home buyer module 244 receiving information indicating that a home buyer desires to purchase property, the information associated with the home buyer may be presented to the real estate agents for a time period, which may any desired period of time (i.e. one day, one week, one month, etc.). After the time period has elapsed or at any desired period of time before the time period has elapsed, the home buyer may select one of the real estate agent's offers to purchase a property with the commission rebate or the home buyer may decline all of the offers.

Home seller module 246 may be configured to receive information from client computing device associated with a home seller desiring to sell a property. The received information from the client computing device may include the location the property the home seller is interested in selling, the desired selling price range of the property, attributes of the property such as the number of bedrooms, bath, square footage, etc. Responsive to receiving the information from the client computing device associated with the home seller desiring to sell a property, a real estate agent using a real estate computing device may transmit a commission offer to sell the property. The transmitted commission offer may indicate a commission percentage fee for the real estate agent if the property is sold. Responsive to receiving a commission offer from a real estate agent, home seller module 246 may parse a database entry within database associated with the real estate agent to receive information associated with the real estate agent's name, years of experience, rating, and reviews.

In embodiments, home seller module 246 may be configured to determine the location where the home seller desires to sell the property, and compare the location where the home seller desires to sell the property with the locations associated with real estate agents with entries within database 240 desire to sell property. Responsive to determining a match in locations, home seller module 246 may transmit a notification to the real estate agent including information indicating that a new home seller desires to sell a property within the location.

In embodiments, responsive to home seller module 246 receiving information indicating that a home seller desires to sell property, the information associated with the property may be presented to the real estate agents for a time period, which may any desired period of time (i.e. one day, one week, one month, etc.). After the time period has elapsed or at any desired period of time before the time period has elapsed, the home seller may select one of the real estate agent's offers to sell the property with the commission, or the home seller may decline all of the offers.

Metric module 250 may be configured to determine a metric to rank real estate agents that have submitted a commission rate to sell a property for home sellers and real estate agents that have submitted a commission rebate to buy a property for home buyers. The metric may rank the order real estate agents are presented in an interface to the home sellers and the home buyers.

In one embodiment, the metric determined by metric module 250 may be a sorting metric associated with a commission rate or rebate, years of experience, and agent ratings. Metric module 250 may be configured to rank the real estate agents based on their sorting metric. In embodiments, metric module 250 may determine the real estate agent's sorting metric by first determining the real estate agent's commission rate or commission rebates, wherein with the real estate agent with the lowest commission rate (or highest commission rebate) has the highest sorting metric, the real estate agent with the second lowest commission rate (or second highest commission rebate) has the second highest sorting metric, etc. In embodiments, if two or more real estate agents have the same commission rate or commission rebate, then metric module 250 may determine that the real estate agent with the highest agent rating has the higher sorting metric. In embodiments, if two or more real estate agents have the same commission rate or commission rebate and agent rating, then metric module 250 may determine that the real estate agent with the highest number of years of experience to have the higher sorting metric.

In one embodiment, the metric determined by metric module 250 may be a weighted metric. The weighted metric may be based on empirical data with different weights being assigned to the commission rebate or commission rate, agent ratings, and number of years in experience. In one embodiment, the weight assigned to the real estate agent's commission rate or commission rebate may be weighted greater than the real estate agent's rating or years of experience. While in further embodiments, the weight assigned to the real estate agent's rating may be higher than the real estate agent's number of years of experience.

Real estate validation module 260 may be configured to validate if a real estate agent is licensed to buy or sell properties in a geographic area. Real estate validation module 260 may be configured to compare the biographical information entered by the real estate agent (i.e. the real estate agent's name) and license number information (i.e. the real estate agent's MLS number) with the MLS information provided from a MLS server or other data source. If the biographical information and the license number information entered by the real estate agent match the biographical information and license number information received from a MLS server, then real estate validation module 260 may determine that the real estate agent is licensed to buy or sell properties in the geographic areas. If the biographical information and the license number information entered by the real estate agent do not match the biographical information and license number information received from a MLS server, then real estate validation module 260 may communicate a notification to the client computing device associated with the real estate agent that either the biographical information and license number entered by the real estate agent are not valid.

Presentation module 270 may be configured to transmit information to a client computing device. The transmitted information may be configured to be presented on a graphical display of the client computing device, wherein the transmitted data to be displayed may include the real estate agents' biographical information, commission rebate or rate, number of years of experience, agent rating, and/or agent reviews. In embodiments, the transmitted information may additionally include the metric associated with the real estate agents', where the information associated with the real estate agents' is presented on the client computing device based on the metric, where the real estate agents' with the higher metrics are presented before the real estate agents' with the lower metrics.

Contract module 280 is configured to form an electronic contract for a home buyer or home seller with a real estate agent. The contract between the home buyer or the home seller and the real estate agent may be formed in response to the home buyer or home seller selecting a real estate agent, where the real estate agent submitted a commission rebate to buy a property for the home buyer or a commission rate to sell a property for the home seller. In one embodiment, contract module 280 may be configured to populate contract fields based on the real estate agent's, the home buyer's and/or the home seller's biographical information, the real estate agent's commission rate or commission rebate, legal text based on the geographic location of the property to be bought or sold. Further, contract module 280 may be configured to transmit fields where the home buyer or the home seller and the real estate agent may electronically sign to form a binding contract between the home buyer or the home seller and the real estate agent at the commission rate or the commission rebate set by the selected real estate agent.

In further embodiments, contract module 280 may require the real estate agent electronically sign the binding contract to sell the property for a home seller at commission rate set in the offer by the real estate agent or buy a property for a home buyer with the commission rebate as set in the offer by the real estate agent. Therefore, the real estate agent's commission rate or rebate will be set before the home seller or home buyer select the real estate agent. In embodiments, a home buyer contract may be for a first length of time (i.e. 180 days), and a home seller contract may be for a second length of time (i.e. 365 days).

Responsive to a contract expiring by the first length of time, the second length of time expiring, or the real estate agent buying or selling a property, the home buyer or seller will be transmitted a notification to write a review for the real estate agent and rate the real estate agent. Responsive to receiving the rating associated with the real estate agent, metric module 250 may dynamically determine a new metric for the real estate agent's current or pending listings to buy or sell homes.

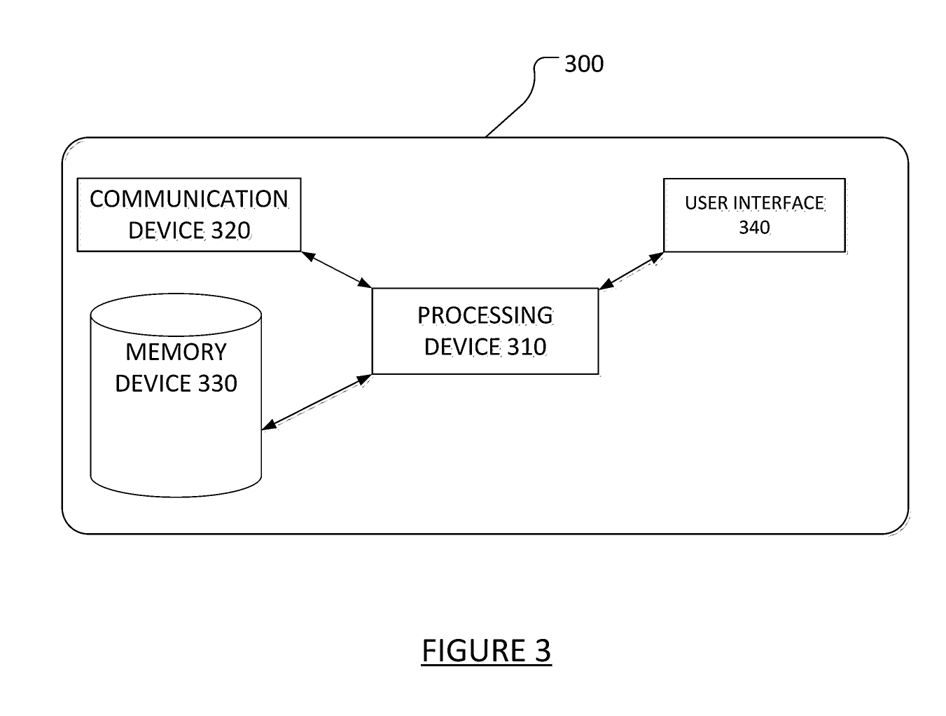

FIG. 3 depicts an embodiment of a block diagram illustrating example components of a computing device 300, which may be a computing device that is, or is similar to client computing device 110 or real estate computing device 140, as depicting in FIG. 1. It should be appreciated that computing device 300 may include additional modules and/or processors, such as those described in FIG. 2. Accordingly, computing device 300 may locally perform actions completed by a data server.

Computing device 300 may include a processing device 310, a communication device 320, a memory device 330, and a user interface 340.

Processing device 310 can include memory, e.g., read only memory (ROM) and random access memory (RAM), storing processor-executable instructions and one or more processors that execute the processor-executable instructions. In embodiments where processing device 310 includes two or more processors, the processors may operate in a parallel or a distributed manner. Processing device 310 may execute an operating system of computing device 300 or software associated with other elements of client computing device 300.

Communication device 320 may be a device that allows computing device 300 to communicate with another device, e.g., a data server over a network. Communication device 320 may include one or more wireless transceivers for performing wireless communication and/or one or more communication ports for performing wired communication.

Memory device 330 may be a device configured to store data generated or received by computing device 300. Memory device 330 may include, but is not limited to a hard disc drive, an optical disc drive, and/or a flash memory drive. Memory device 330 may be configured to store data associated a home buyer buying a property, a home seller selling a property, or a real estate agent.

User interface 340 may be a device that allows a real estate agent, home buyer, or home seller to interact with computing device 300 or a data server over a network. While one user interface is shown, the term “user interface” may include, but is not limited to being, a touch screen, a physical keyboard, a mouse, a camera, a video camera, a microphone, and/or a speaker.

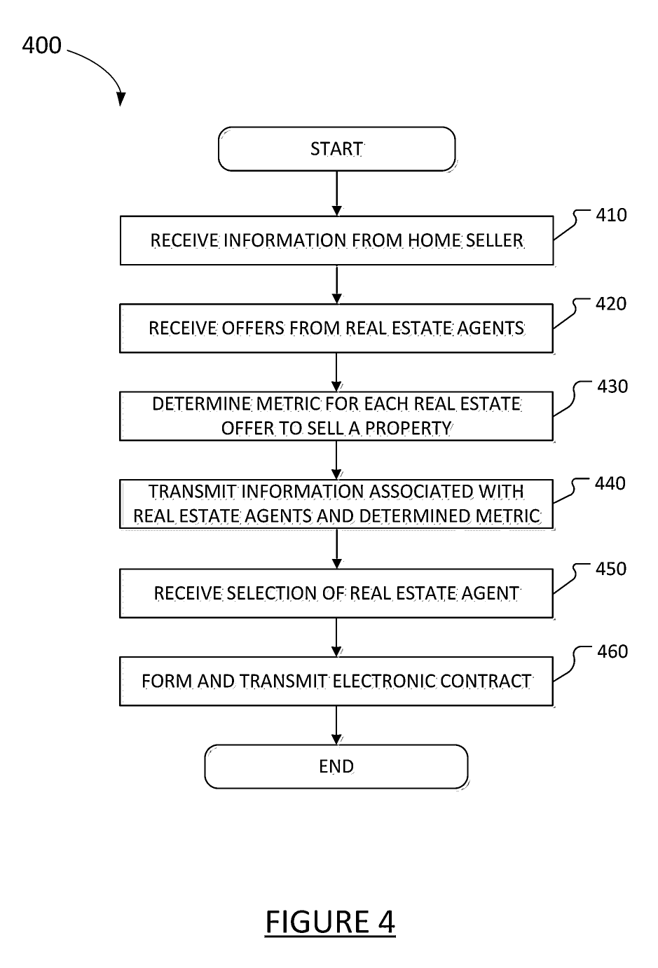

FIG. 4 depicts a method 400 for a home seller selecting a real estate agent to sell a property. The operations of method 400 presented below are intended to be illustrative. In some embodiments, method 400 may be accomplished with one or more additional operations not described, and/or without one or more of the operations discussed. Additionally, the order in which the operations of method 400 are illustrated in FIG. 4 and described below are not intended to be limiting. In some embodiments, method 400 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 400 in response to instructions stored electronically on an electronic storage medium. The one or more processing devices may include one or more devices configured through hardware, firmware, and/or software to be specifically designed for execution of one or more of the operations of method 400.

At operation 410, information associated with a home seller creating a new listing to have a real estate agent submit offers to sell their home may be received. The received information may include information associated with the location of the property such as the state, address, city, and zip code of the property, property details such as a desired selling price, type of property, number of bedrooms and baths, square footage, and if the property is a short sale or not, and additional information associated with the property such as a photo. In embodiments, the created listings will be made available for real estate agents to submit bids to sell the home seller's home for a predetermined selling period of time, which may be any desired length of time (i.e. one day, one week, one month, etc.). Operation 410 may be performed by a home seller module that is the same as or similar to home seller module 246, in accordance with one or more implementations.

At operation 420, offers from real estate agents desiring to sell the property may be received. A received offer may include a commission percentage fee that the associated real estate agent may receive if the property is sold. Responsive to receiving a commission offer from a real estate agent, information associated with the real estate agent's name, years of experience, rating, and reviews may be determined. Operation 420 may be performed by a home seller module that is the same as or similar to home seller module 246, in accordance with one or more implementations.

At operation 430, a metric may be determined for each real estate agent that submitted an offer to sell a property. The metric may be based on empirical data with different weights being assigned to real estate agent's commission rate, ratings, and number of years in experience. In one embodiment, the weight assigned to the real estate agent's commission rate may be weighted greater than the real estate agent's rating or years of experience. While in further embodiments, the weight assigned to the real estate agent's rating may be higher than the real estate agent's number of years of experience. The weighted metric may be utilized to rank the real estate agents that submitted an offer to sell a property, such that the ranking is not based solely on the lowest commission rate but based on the likelihood that the real estate agent will be able to sell the property for the highest price during a desired time period. Operation 430 may be performed by a metric module that is the same as or similar to metric module 250, in accordance with one or more implementations.

At operation 440, information may be transmitted to be displayed on a client computing device. The transmitted data to be displayed may include for each real estate agent that submitted an offer to sell the property, the real estate agent's biographical information, commission rate, number of years of experience, agent rating, and/or agent reviews. In embodiments, the transmitted information may additionally include the metric associated with the real estate agents', where the real estate agents' with the higher metrics are presented before the real estate agents' with the lower metrics. Operation 440 may be performed by a presentation module that is the same as or similar to presentation module 270, in accordance with one or more implementations.

At operation 450, information may be received associated with a selection of a real estate agent presented on a client computing device. The received information may indicate which real estate agent the home seller selected to sell the property. If the information associated with the selection of the real estate agent is not received within the selling time period, then the received information may indicate that the home seller has declined all of the real estate agents' offers to sell the property. Operation 450 may be performed by a home seller module that is the same as or similar to home seller module 246, in accordance with one or more implementations.

At operation 460, an electronic contract for the real estate agent to sell the property associated with the home seller may be formed, and transmitted to the selected real estate agent and the home seller. Operation 460 may be performed by a contract module that is the same as or similar to contract module 280, in accordance with one or more implementations.

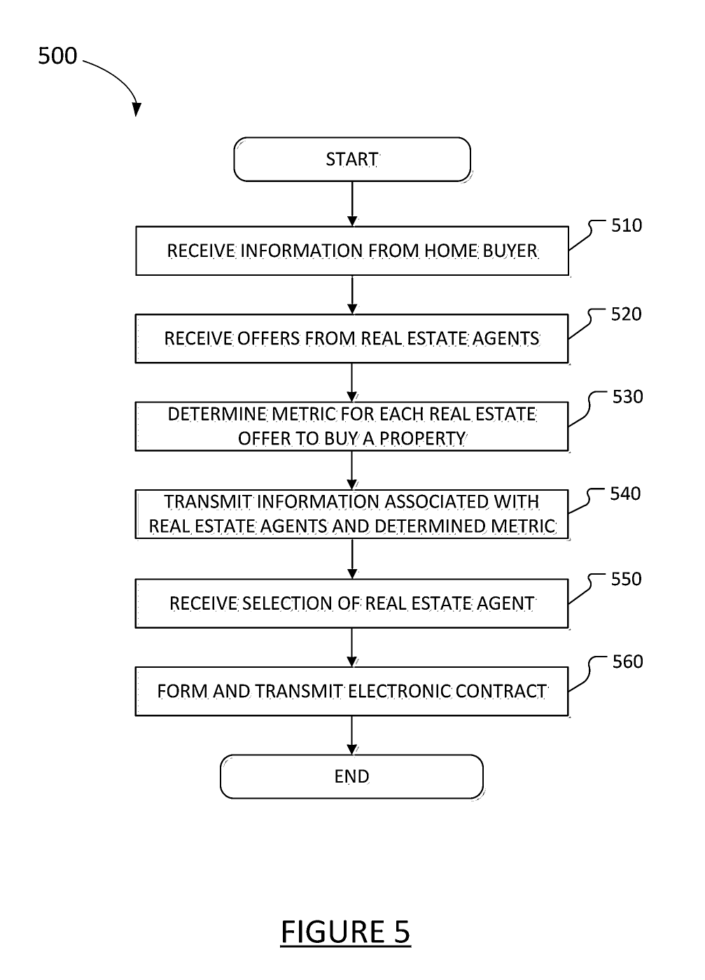

FIG. 5 illustrates a method 500 for a home buyer selecting a real estate agent to buy a property. The operations of method 500 presented below are intended to be illustrative. In some embodiments, method 500 may be accomplished with one or more additional operations not described, and/or without one or more of the operations discussed. Additionally, the order in which the operations of method 500 are illustrated in FIG. 5 and described below are not intended to be limiting. In some embodiments, method 500 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 500 in response to instructions stored electronically on an electronic storage medium. The one or more processing devices may include one or more devices configured through hardware, firmware, and/or software to be specifically designed for execution of one or more of the operations of method 500.

At operation 510, information associated with a home buyer creating a new listing to have a real estate agent submit offers to buy a property may be received. The received information may include information associated with the location the buyer desires to purchase property, the price range of the desired property, the type of purchase, and attributes associated with the desired property. In embodiments, the created listings will be made available for real estate agents to submit bids to purchase a property for the home buyer for a predetermined buying period of time, which may be any desired length of time (i.e. one day, one week, one month, etc.). Operation 510 may be performed by a home buyer module that is the same as or similar to home buyer module 244, in accordance with one or more implementations.

At operation 520, offers from real estate agents desiring to purchase a property for the home buyer may be received. A received offer may include a commission rebate percentage fee that the associated real estate agent may give to the home buyer if a property is purchased. Responsive to receiving a commission rebate offer from a real estate agent, information associated with the real estate agent's name, years of experience, rating, and reviews may be determined. Operation 520 may be performed by a home buyer module that is the same as or similar to home buyer module 244, in accordance with one or more implementations.

At operation 530, a metric may be determined for each real estate agent that submitted an offer to purchase a property for the home buyer. The metric may be based on empirical data with different weights being assigned to real estate agent's commission rebate percentage, ratings, and number of years of experience. In one embodiment, the weight assigned to the real estate agent's commission rebate rate may be weighted greater than the real estate agent's rating or years of experience. While in further embodiments, the weight assigned to the real estate agent's rating may be higher than the real estate agent's number of years of experience. The weighted metric may be utilized to rank the real estate agents that submitted an offer to purchase a property for the home buyer, such that the ranking is not based solely on the lowest commission rebate rate but based on the likelihood that the real estate agent will be able to purchase the best property for the lowest price during a desired time period. Operation 530 may be performed by a metric module that is the same as or similar to metric module 250, in accordance with one or more implementations.

At operation 540, information may be transmitted to be displayed on a client computing device. The transmitted data to be displayed may include the real estate agents' biographical information, commission rebate rate, number of years of experience, agent rating, and/or agent reviews. In embodiments, the transmitted information may additionally include the metric associated with the real estate agents', where the real estate agents' with the higher metrics are presented before the real estate agents' with the lower metrics. Operation 540 may be performed by a presentation module that is the same as or similar to presentation module 270, in accordance with one or more implementations.

At operation 550, information may be received associated with a selection of a real estate agent presented on a client computing device. The received information may indicate which real estate agent the home buyer selected to purchase a property. If the information associated with the selection of the real estate agent is not received within the buying time period, then the received information may indicate that the home buyer has declined all of the real estate agents' offers to purchase a property. Operation 550 may be performed by a home buyer module that is the same as or similar to home buyer module 244, in accordance with one or more implementations.

At operation 560, an electronic contract for the real estate agent to purchase the property associated with the home buyer may be formed, and transmitted to the selected real estate agent and the home buyer. Operation 560 may be performed by a contract module that is the same as or similar to contract module 280, in accordance with one or more implementations.

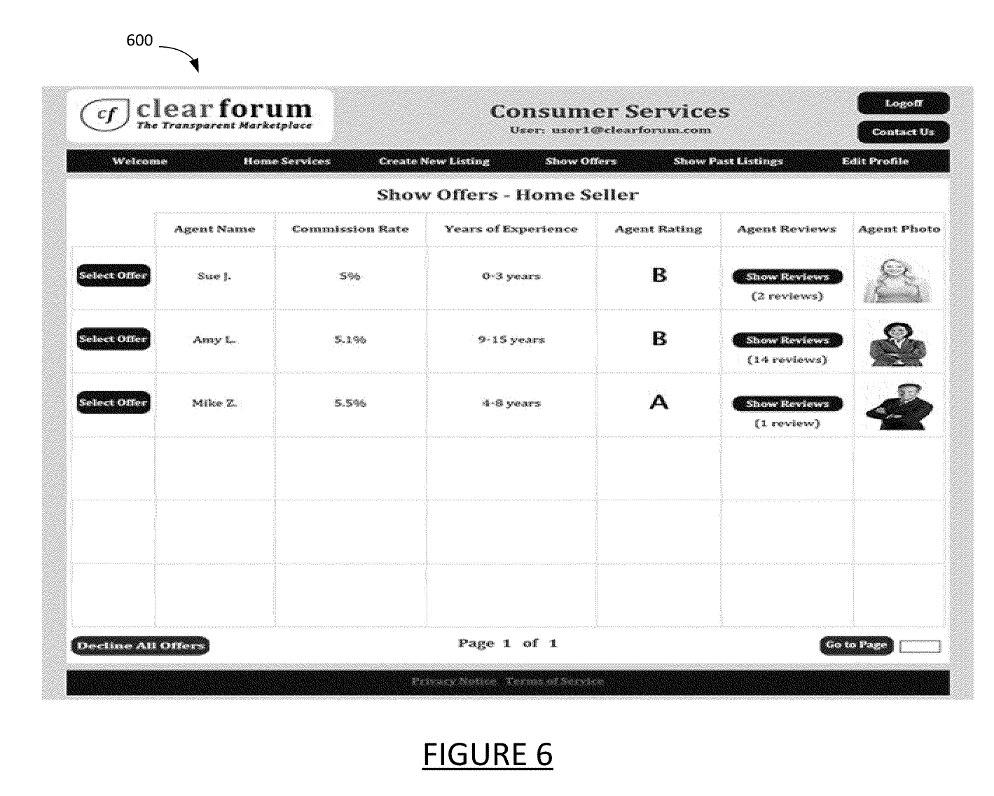

FIG. 6 depicts an interface 600 configured to be presented on a client computing device associated with a home seller. Screenshot 600 may include information associated with real estate agents that submitted a bid to sell a property for a home seller. The real estate agents may be presented on the client computing device in an order based on the real estate agent's metric, where the real estate agents with a higher metric are presented before the real estate agents with a lower metric.

In embodiments, the metric may be based on the real estate agent's commission rate, agent rating, and number of years of experience, where each of the commission rate, agent rating, and number of years of experience are weighted. In embodiments, the weights associated with the commission rate, agent rating, and number of years of experience may be different weights.

A home seller utilizing user of a client computing device may interact with interface 600 to order the presentation of the real estate agents based on the real estate agents' commission rate, number of years of experience, or agent rating, where the real estate agents with the highest or lowest commission rate, number of years of experience, or agent rating may be presented higher or lower, respectively. In embodiments, the home seller may perform commands to interact with interface 600 to select one of the presented real estate agents to sell the property. Responsive to the home seller performing commands to select one of the presented real estate agents, a contract may be prepared and transmitted to the home seller and the selected real estate agent.

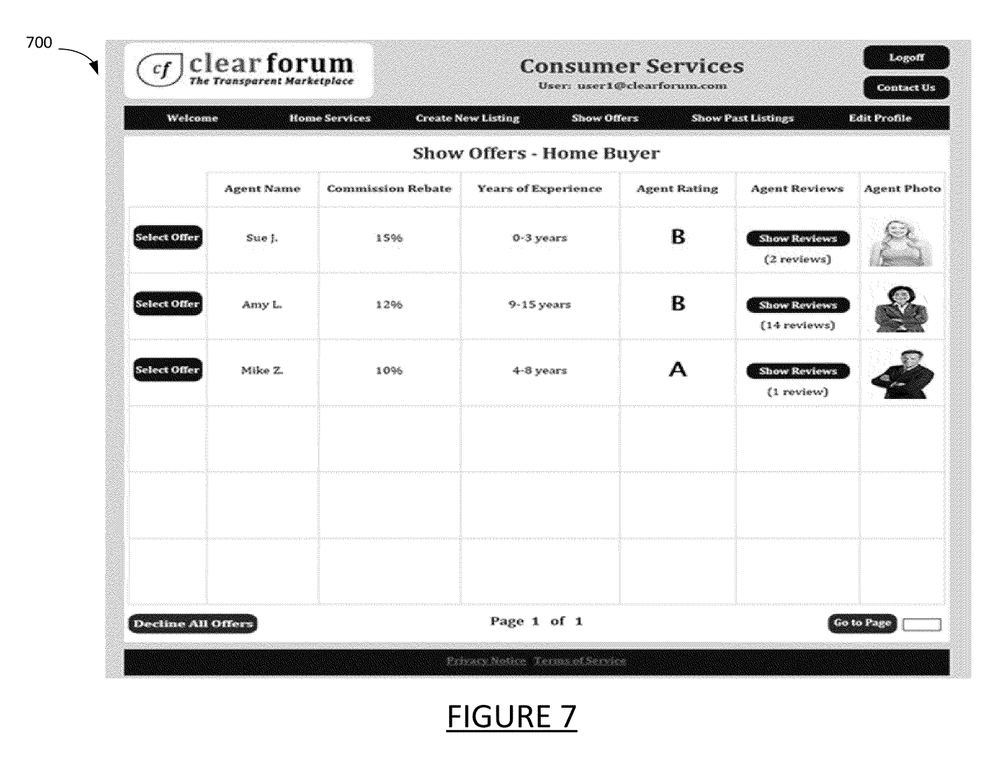

FIG. 7 depicts an interface 700 configured to be presented on a client computing device associated with a home buyer. Screenshot 700 may include information associated with real estate agents that submitted a bid to purchase a property for a home buyer. The real estate agents may be presented on the client computing device in an order based on the real estate agent's metric, where the real estate agents with a higher metric are presented before the real estate agents with a lower metric.

In embodiments, the metric may be based on the real estate agent's commission rebate rate, agent rating, and number of years of experience, where each of the commission rebate rate, agent rating, and number of years of experience are weighted. In embodiments, the weights associated with the commission rebate rate, agent rating, and number of years of experience may be different weights.

A home buyer utilizing user of a client computing device may interact with interface 700 to order the presentation of the real estate agents based on the real estate agents' commission rebate rate, number of years of experience, or agent rating, where the real estate agents with the highest or lowest commission rebate rate, number of years of experience, or agent rating may be presented higher or lower, respectively. In embodiments, the home buyer may perform commands to interact with interface 700 to select one of the presented real estate agents to purchase a property for the home buyer. Responsive to the home buyer performing commands to select one of the presented real estate agents, a contract may be prepared and transmitted to the home buyer and the selected real estate agent.

Although the present technology is described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

Embodiments may be implemented as an apparatus, method, or computer program product. Accordingly, the present embodiments may take the form of an entirely hardware embodiment, an entirely software embodiment (including firmware, resident software, micro-code, etc.), or an embodiment combining software and hardware aspects that may all generally be referred to herein as a “module” or “system.” In embodiments, a module may refer to a hardware processor configured to store and/or execute embodiments or specific portions of embodiments. Furthermore, the present embodiments may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present embodiments may be written in any combination of one or more programming languages.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The flowchart and block diagrams in the flow diagrams illustrate the architecture, functionality, and operation of possible implementations of systems, methods, and computer program products according to various embodiments of the present embodiments. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

As used herein, the terms “comprises,” “comprising,” “includes,” “including,” “has,” “having,” or any other variation thereof, are intended to cover a non-exclusive inclusion. For example, a process, article, or apparatus that comprises a list of elements is not necessarily limited to only those elements but may include other elements not expressly listed or inherent to such process, article, or apparatus.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Additionally, any examples or illustrations given herein are not to be regarded in any way as restrictions on, limits to, or express definitions of any term or terms with which they are utilized. Instead, these examples or illustrations are to be regarded as being described with respect to one particular embodiment and as being illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example,” “for instance,” “e.g.,” and “in one embodiment.”

What is claimed is:

1. A system to match a real estate agent with a client, the system comprising:
a real estate module configured to receive data associated with real estate agents;
a metric module configured to determine a metric for each of the real estate agents based on a commission rate of each of the real estate agents, a rating of each of the real estate agents, and a number of years of experience of each of the real estate agents;
a presentation module configured to transmit information configured to be presented on a client computing device over a network, the transmitted information including the received data associated with the real estate agents and being presented on the client computing device based on the metric for each of the real estate agents.

2. The system of claim 1, further comprising:
a home buyer module configured to receive information associated with a home buyer that wants to purchase a property, to transmit the received information associated with the home buyer to the real estate agents, and to receive offers from the real estate agents to purchase the property for the home buyer, where the received offers include a commission rebate rate.

3. The system of claim 2, wherein the commission rebate rate is a percentage of a purchase price of the property distributed from a selected real estate agent to the home buyer, and the commission rate is the commission rebate rate.

4. The system of claim 3, wherein a first real estate agent has a first commission rebate rate and a first metric, and a second real estate agent has a second commission rebate rate and second metric, the first commission rebate rate being higher than the second commission rebate rate and the first metric being higher than the second metric.

5. The system of claim 1, further comprising:
a home seller module configured to receive information associated with a home seller that wants to sell a property, to transmit the received information associated with the home seller to the real estate agents, and to receive offers from the real estate agents to sell the property for the home seller, the offers including the commission rate.

6. The system of claim 5, wherein the commission rate is a percentage of a selling price of the property.

7. The system of claim 6, wherein a first real estate agent has a first commission rate and a first metric, and a second real estate agent has a second commission rate and second metric, the first commission rate being lower than the second commission rate and the first metric being higher than the second metric.

8. The system of claim 1, wherein the rating associated with each of the real estate agents is based on the associated real estate agents ability to purchase or sell a house at a desired price within a given time period.

9. The system of claim 1, further comprising:
a contract module configured to transmit an electronic contract to a selected one of the real estate agents and the client, wherein the contract is enforceable for a period of time, wherein the period of time is based on if the selected real estate agent is buying or selling a property for the client.

10. The system of claim 9, wherein responsive to the period of time expiring or a property being bought or sold, receiving a rating of the selected real estate agent based on an amount of time the real estate agent took to buy or sell the property and a price of the bought or sold property.

11. A method of matching a real estate agent with a client, the method comprising:
receiving data associated with real estate agents,
determining a metric for each of the real estate agents based on a commission rate, a rating of each of the real estate agents, and a number of years of experience of each of the real estate agents;
transmitting information over a network configured to be presented on a client computing device, the transmitted information including the received data associated with the real estate agents and being presented on the client computing device based on the metric for each of the real estate agents.

12. The method of claim 11, further comprising:
receiving information associated with a home buyer that wants to purchase a property;
transmitting the received information associated with the home buyer to the real estate agents; and
receiving offers from the real estate agents to purchase the property for the home buyer, wherein the received offers include a commission rebate rate.

13. The method of claim 12, wherein the commission rebate rate is a percentage of a purchase price of the property distributed from a selected real estate agent to the home buyer, and the commission rate is the commission rebate rate.

14. The method of claim 13, wherein a first real estate agent has a first commission rebate rate and a first metric, and a second real estate agent has a second commission rebate rate and second metric, the first commission rebate rate being higher than the second commission rebate rate and the first metric being higher than the second metric.

15. The method of claim 11, further comprising:
receiving information associated with a home seller that wants to sell a property;
transmitting the received information associated with the home seller to the real estate agents; and
receiving offers from the real estate agents to sell the property for the home seller, the offers including the commission rate.

16. The method of claim 15, wherein the commission rate is a percentage of a selling price of the property.

17. The method of claim 16, wherein a first real estate agent has a first commission rate and a first metric, and a second real estate agent has a second commission rate and second metric, the first commission rate being lower than the second rebate rate and the first metric being higher than the second metric.

18. The method of claim 11, wherein the rating associated with each of the real estate agents is based on the associated real estate agents ability to purchase or sell a house at a desired price within a given time period.

19. The method of claim 18, further comprising:
transmitting an electronic contract to a selected one of the real estate agents and the client, wherein the contract is enforceable for a period of time, wherein the period of time is based on if the selected real estate agent is buying or selling a property for the client.

20. The method of claim 19, wherein responsive to the period of time expiring or a property being bought or sold, receiving a rating of the selected real estate agent based on an amount of time the real estate agent took to buy or sell the property and a price of the bought or sold property.
